(19) United States
(12) Patent Application Publication
(10) Pub. No.: US 2015/0017016 A1
(43) Pub. Date: Jan. 15, 2015

(54) DIRECT DRIVE WIND TURBINE

(71) Applicant: Haynie Prince Beall, Estes Park, CO (US)

(72) Inventor: Haynie Prince Beall, Estes Park, CO (US)

(21) Appl. No.: 13/938,375

(22) Filed: Jul. 10, 2013

(51) Int. Cl. F03D 9/00

(52) U.S. Cl. CPC F03D 9/002
USPC 416/244 A

(57) ABSTRACT

A wind turbine has a rotating forward hub with turbine blades and a relatively large diameter field for a generator, and a rotating rearward hub with an armature that fits concentrically with the field. The forward hub moves forwardly in still air and in low winds to axially separate the field and armature. The forward hub moves rearwardly as winds increase to axially align the field and armature to generate electricity. A counter rotating mechanism counter rotates the armature relative to the field to increase the electricity generated.

### TECHNICAL FIELD

The present invention relates to the wind turbines and more particularly to a wind turbine with a direct drive generator with counter-rotating armature and field that axially align when the wind increases and axially separate during low winds.

### BACKGROUND ART

The amount of electrical power generated in a wind turbine depends on the strength of the magnetic flux, number of wires wrapped around the coils and the relative speed between the magnets and coils. Two types of wind turbines are currently in use. In one type, a gearbox or transmission links the turbine rotor, with the turbine blades, to the electrical generator. The gearbox increases the speed or rotational rate of the generator relative to the speed of the turbine rotor to efficiently generate electricity.

The other type of wind turbine, known as a direct drive wind turbine, directly links the turbine rotor to the generator, such that the turbine rotor and the generator rotate at the same speed. Direct drive wind turbines eliminate the cost of the gearbox, reduce the number of parts and eliminate the costs of maintaining the gearbox. The generator in a direct drive wind turbine must have a relatively large radius in order to produce a high enough relative speed between the magnets and coils to efficiently generate electricity at the relatively low rotational speed of the turbine rotor.

The relatively large radius generator in known direct drive wind turbines is covered by a boxy nacelle that creates drag and wind blockage. Known generators for direct drive wind turbines must be sufficiently rigid to overcome the magnetic attraction force and maintain the air gap between the armature and field. This required rigidity results in a large structural mass for these generators.

A proposed improvement to the known generators for direct drive wind turbines has an air-core armature and a field with magnets on both sides of the armature. This proposed design eliminates the torsional forces on the armature and localizes the torsional forces on the field, allowing a significant weight reduction.

Cogging torque in permanent magnet generators can affect the self-start ability of direct drive wind turbines. Cogging torque can also reduce the low wind performance, and create intermittent vibrations in direct drive wind turbines. Air-core armatures are often used to reduce the cogging torque. Iron-core armatures, such as with laminated silicon steel, increase the inductance, and thereby increase the power output of the generator.

### SUMMARY OF THE INVENTION

A direct drive wind turbine includes a tower, a shaft support mounted on the tower, a rotatable rearward hub on the shaft support, a shaft mounted in the shaft support, a rotatable forward hub mounted on the shaft forward of the shaft support, turbine blades mounted on the forward hub, an armature mounted on the rearward hub and a field mounted on the forward hub. The shaft tilts forwardly, downwardly, and slides in the shaft support, allowing the forward hub to move between a forward first position and a rearward second position. The field has an inner cylinder of magnets and a radially spaced, concentric outer cylinder of magnets. The armature is sized to fit between the inner and outer cylinders of the field, and has a plurality of coils. When the forward hub is in the first position, the field is axially forward of the armature, and as the forward hub moves to the second position, the inner and outer cylinders of the field progressively overlap the armature. Gravity pulls the forward hub forwardly, biasing the forward hub towards the first position. Wind on the blades rotates the forward hub and progressively pushes the forward hub rearwardly to the second position, to axially align the field and armatures and generate electricity.

### BRIEF DESCRIPTION OF THE DRAWINGS

Details of this invention are described in connection with the accompanying drawings that bear similar reference numerals in which:

FIG. 1 is a perspective view of a wind turbine embodying features of the present invention.

FIG. 2 is a front elevation view of the wind turbine of FIG. 1.

FIG. 3 is a side elevation view of the wind turbine of FIG. 1.

FIG. 4 is a sectional view of the generator and turbine rotor of the wind turbine of FIG. 1 taken along line 4-4 of FIG. 2, in the forward, first position, with the tower strut cut away to show the interior of the storage tank.

FIG. 5 is a sectional view of the generator and turbine rotor of the wind turbine of FIG. 1 taken along line 4-4 of FIG. 2, in the rearward, second position, with the tower strut cut away to show the interior of the storage tank.

FIG. 6 is a sectional view of the generator and turbine rotor of the wind turbine of FIG. 1 taken along line 6-6 of FIG. 3.

FIG. 7 is an enlarged partial view showing the counter rotating mechanism of FIG. 5.

FIG. 8 is an inside view of the intermediate portion of the counter rotating mechanism of FIG. 7.

### DETAILED DESCRIPTION OF THE INVENTION

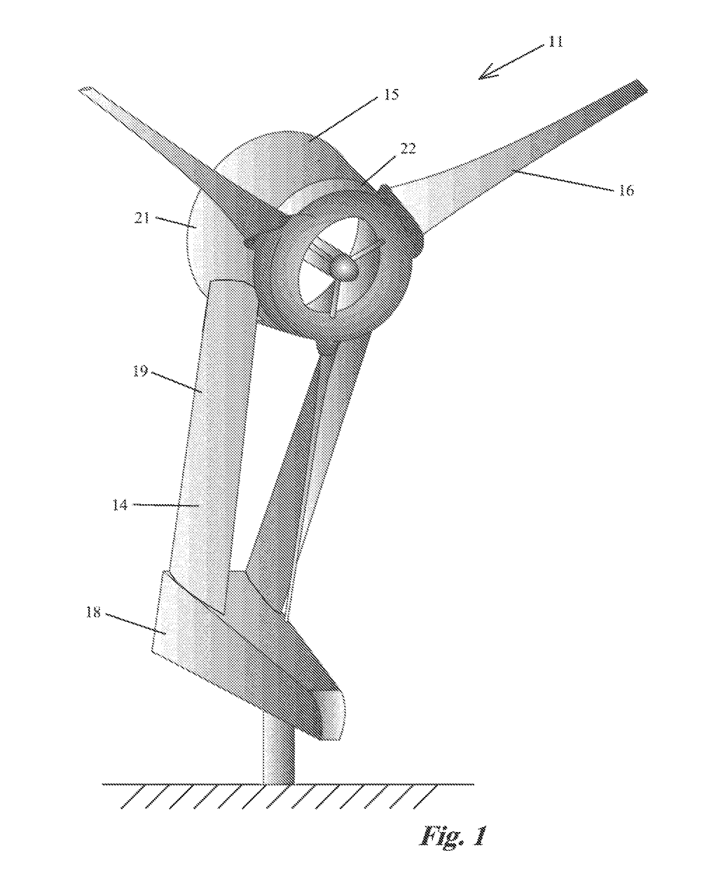

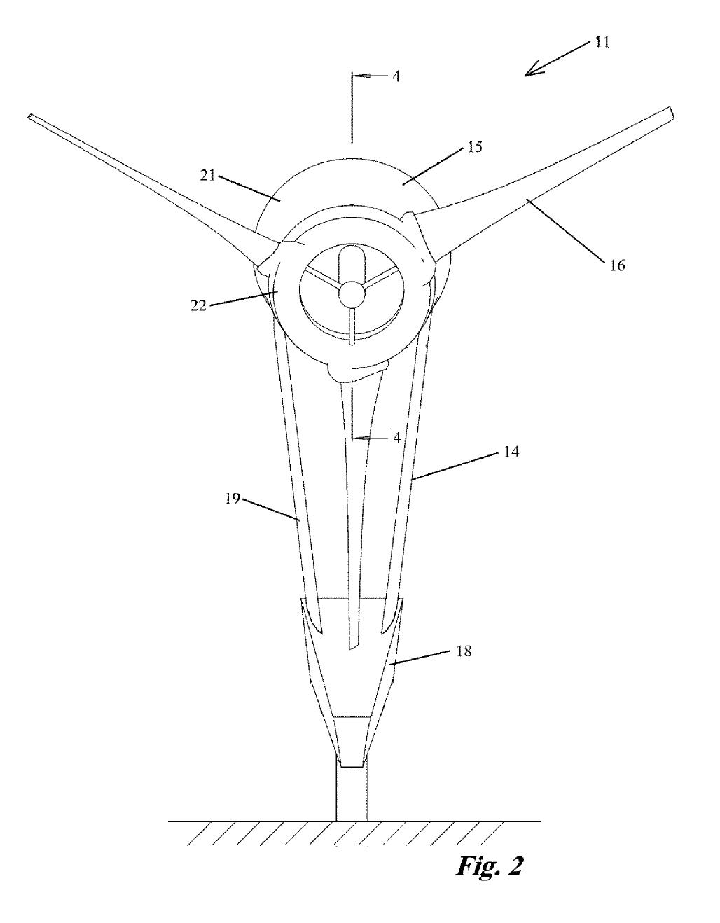

Referring to FIGS. 1-3, a wind turbine 11, embodying features of the present invention, includes a tower 14, an aerodynamic diffuser ring 15 and a plurality of turbine blades 16. The tower 14 has a base 18 and a pair of spaced, elongated struts 19 that project upwardly from the base 18. The struts 19 have an airfoil shape with a significantly greater fore/aft dimension than the side to side dimension, for low wind resistance in the frontal direction. The struts 19 splay outwardly. The base 18 rotates to point the wind turbine 11 into the wind.

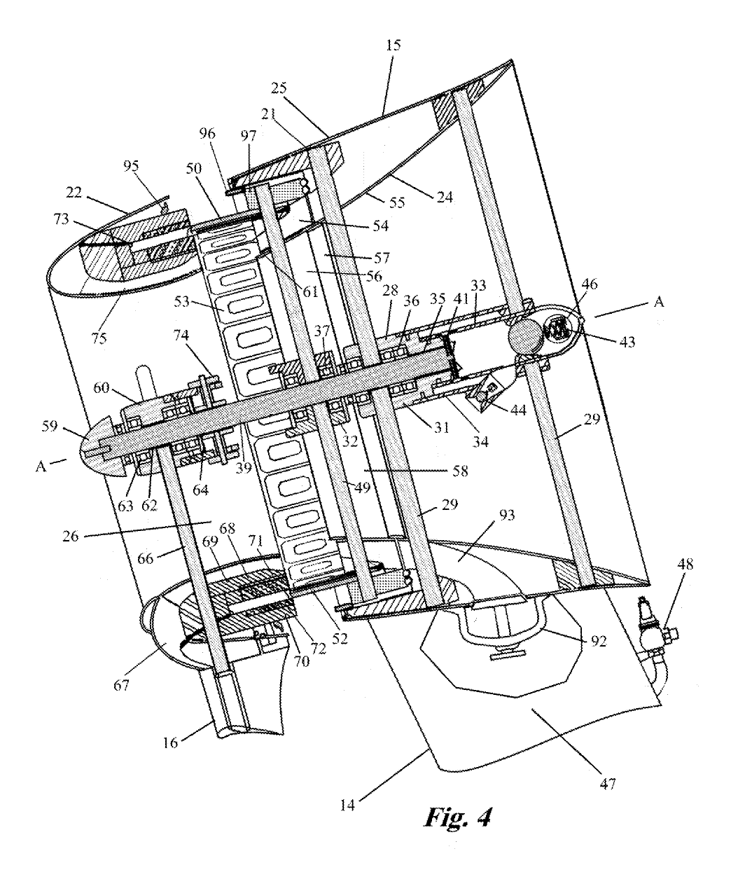

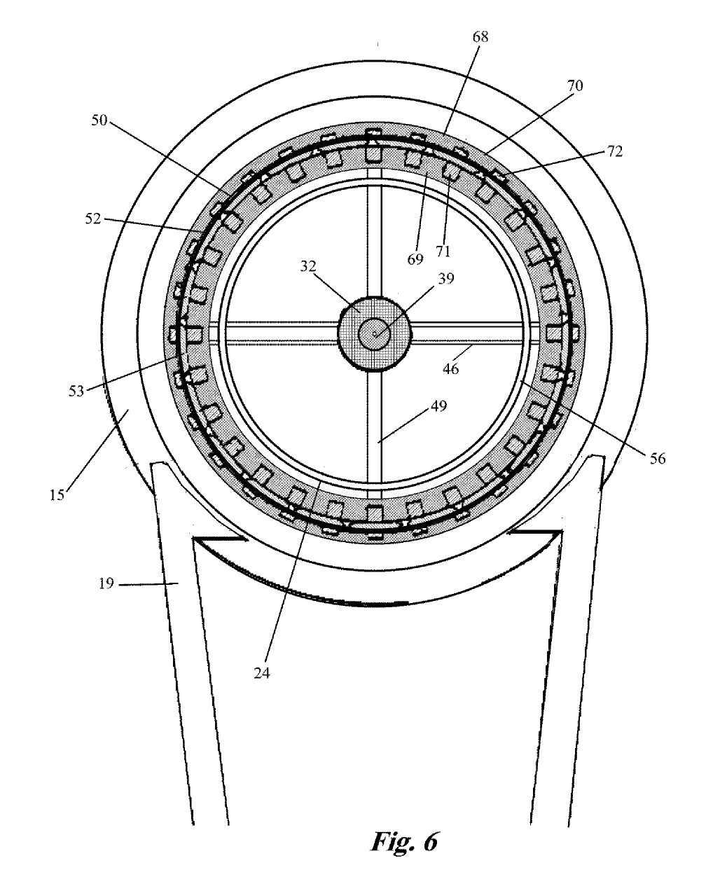

The diffuser ring 15 has a rearward portion 21 and a forward portion 22. The rearward portion 21 mounts on the tops of the two struts 19 of the tower 14. As shown in FIGS. 4-6, the diffuser ring 15 has an airfoil shaped cross section with an inner wall 24 and a spaced outer wall 25. The inner and outer walls 24 and 25 meet along a curve at the front and converge to a point at the back. The inner wall 24 converges and then diverges from front to back, to a large exit, defining a passage 26 with an effective diffuser shape. The diffuser ring 15 has a relatively large radius. Preferably the radius of the forward portion 22 of the diffuser ring 15 is about twenty percent of the turbine blade 16 radius. The open diffuser ring 15 reduces drag and wind blockage relative to conventional nacelles.

A shaft support 28 is located in the center of the rearward portion 21 of the diffuser ring 15. Two sets of longitudinally spaced rods 29 project radially outwardly from the shaft support 28 to the rearward portion 21 of the diffuser ring 15 to support the shaft support 28. Each set of rods 29 includes a plurality of circumferentially spaced rods 29. The rods 29 shown are spaced 90 degrees apart with four rods 29 in each set.

The shaft support 28 includes a substantially cylindrical body 31, a rotatable rearward hub 32 connected to the front of the body 31, and spaced inner and outer pump walls 33 and 34 that extend rearwardly from the body 31. A shaft cavity 35 extends longitudinally through the body 31 and rearward hub 32. Shaft bearings 36 in the body 31 and rearward hub bearings 37 in the rearward hub 32 surround the shaft cavity 35.

An elongated, cylindrical shaft 39 mounts in the shaft cavity 35 and defines an axis A-A. The shaft 39 is supported by and movable axially on the shaft bearings 36. The shaft 39 projects rearwardly into the inner pump wall 33 and forwardly from the rearward hub 32. The rearward hub bearings 37 support the rearward hub 32 on the shaft 39.

A pump piston 41 mounts on the rearward end of the shaft 39, extends radially outwardly to the inner pump wall 33, sealing against the inner pump wall 33. The rearward end of the body 31 limits forward movement of the pump piston 41 and thereby prevents the shaft 39 from forward movement beyond a selected position.

An outlet check valve 43 connects across and seals the rearward end of the inner pump wall 33. An inlet valve 44 is mounted on the inner pump wall 33. The pump piston 41 in combination with the inner and outer pump walls 33 and 34 provide a double acting pump. As the shaft 39 moves forwardly, the pump piston 41 pushes air into the space between the inner and outer pump walls 33 and 34 while pulling air into the space inside the inner pump wall 33. As the shaft 39 moves rearwardly, the pump piston 41 pushes the air out through the outlet check valve 43. The outlet check valve 43 is connected by tubes 46 to storage tanks 47 in the struts 19 of the tower 14. Pressure relief valves 48 protect the struts 19 in case of overpressure.

A plurality of rods 49 project outwardly from the rearward hub 32. An armature 50 for a generator mounts near the ends of the rods 49, partially inside the rearward portion 21 of the diffuser ring 15. The armature 50 includes a coils cylinder 52 and a plurality of coils 53. The coils cylinder 52 mounts on the rods 49 and projects forwardly beyond the front of the rearward portion 21 of the diffuser ring 15. The coils 53 are mounted in a spaced circumferential arrangement on the inside of the coils cylinder 52.

The coils 53 are preferably iron core coils. The coils 53 are more preferably laminated silicon steel core coils. Slip rings with spring contacts or brushes, not shown, can be used to electrically connect the rotating armature 50 and conduct generated electricity from the armature 50. A plurality of spaced, C shaped, impeller vanes 54 project inwardly from the coils cylinder 52, behind the forward end of the outer wall 25 of the rearward portion 21 of the diffuser ring 15. The vanes 54 are angled, extending rearwardly and laterally.

The inner wall 24 of the rearward portion 21 of the diffuser ring 15 has a stationary rearward section 55 that connects to the outer wall 25 of the rearward portion 21 of the diffuser ring 15, and a forward section 56 that mounts on the inner ends of the vanes 54 and rotates with the rearward hub 32. A seal 57 extends between and prevents air leakage between the rearward and forward sections 55 and 56. A seal 61 projects forwardly from the forward section 56. The rearward hub 32, the rods 49, the armature 50, the vanes 54, and the forward section 56 of the inner wall 24 of the rearward portion 21 of the diffuser ring 15 form a rearward rotor 58.

An aerodynamic nose portion 59 mounts on the front end of the shaft 39. A forward hub 60 mounts on the shaft 39 behind the nose portion 59. A shaft cavity 62, sized to receive the shaft 39, extends longitudinally through the forward hub 60. Hub bearings 63 in the forward hub 60 surround the shaft cavity 62, supporting the forward hub 60 on the shaft 39 and allowing the forward hub 60 to rotate on the shaft 39. A thrust bearing 64 behind the forward hub 60 prevents axial movement of the forward hub 60 relative to the shaft 39.

A plurality of rods 66 project radially outwardly from the forward hub 60. The forward portion 22 of the diffuser ring 15 mounts on the rods 66. The turbine blades 16 project radially outwardly from the forward portion 22 of the diffuser ring 15 with the rods 66 projecting into the bases of the turbine blades 16 at the thickest airfoil section, about 25% of the chord. A field 68 for a generator mounts directly on the rods 66 inside of the forward portion 22 of the diffuser ring 15. The field 68, in combination with the forward hub 60, the rods 66, the forward portion 22 of the diffuser ring 15 and the turbine blades 16 form a forward rotor 67.

The field 68 includes an inner cylinder 69 and a radially outwardly spaced outer cylinder 70. The inner and outer cylinders 69 and 70 project rearwardly from the rods 66. A plurality of circumferentially spaced inner magnets 71 are mounted on the outer side of the inner cylinder 69 and a plurality of circumferentially spaced outer magnets 72 are mounted on the inner side of the outer cylinder 70. Preferably the inner and outer magnets 71 and 72 are permanent magnets.

The inner cylinder 69 is sized to fit inside of the coils cylinder 52 with a small, uniform air gap to prevent contact between the inner cylinder 69 and the coils cylinder 52. The outer cylinder 70 is sized to fit outside of the coils cylinder 52 with a small, uniform air gap to prevent contact between the outer cylinder 70 and the coils cylinder 52. A plurality of spaced, C shaped, impeller vanes 75 project inwardly from the inner cylinder 69 to the inner wall 24 of the forward portion 22 of the diffuser ring 15.

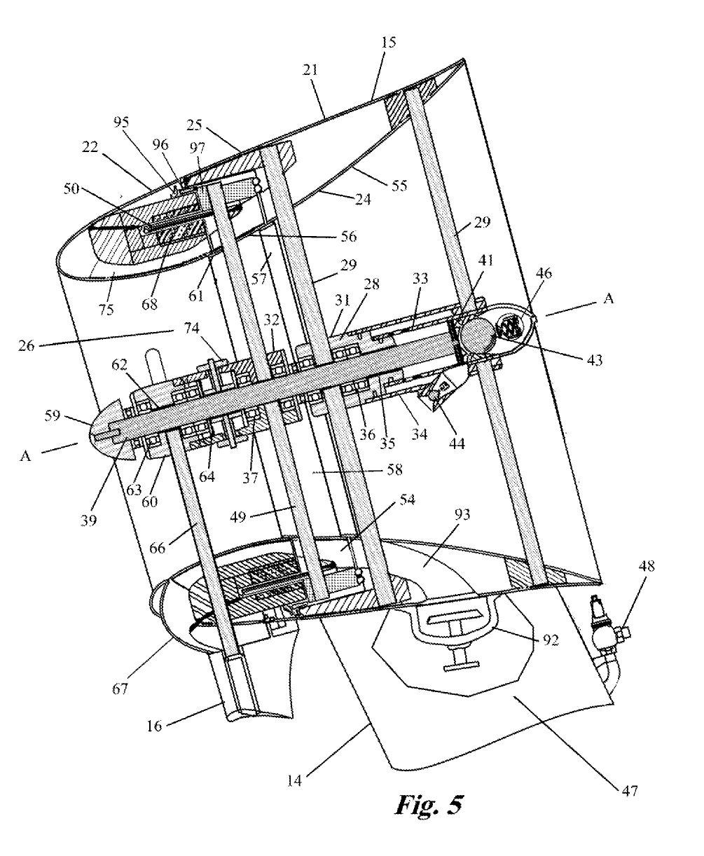

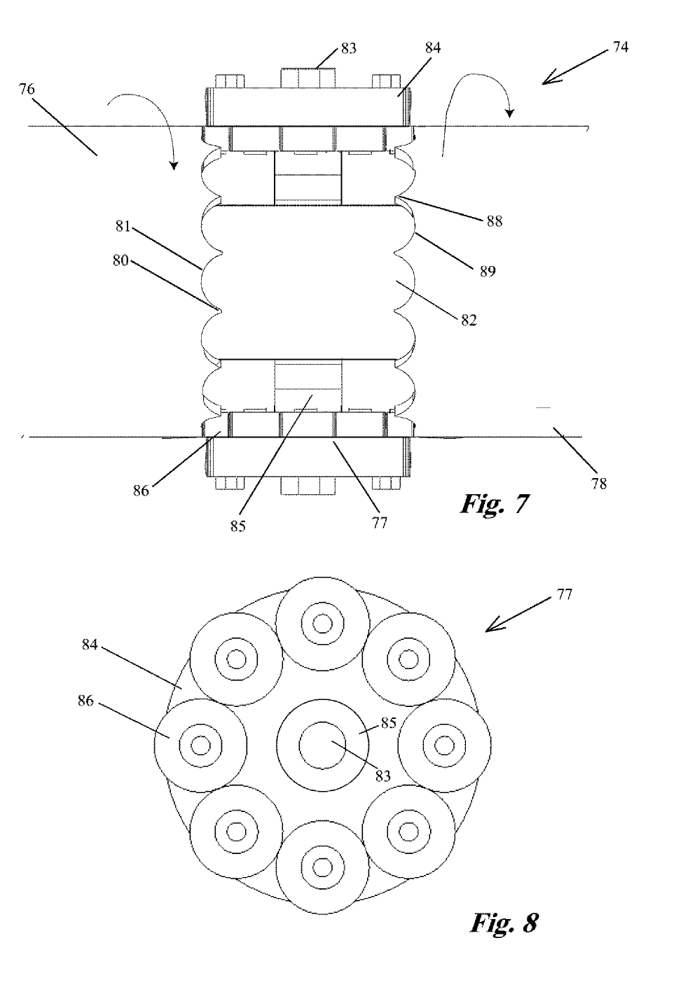

FIG. 4 shows the forward hub 60 and the shaft 39 in a forward first position. In the first position the field 68 is in front of the armature 50 so that the armature 50 and the field 68 are axially separated. FIGS. 5 and 7 show the forward hub 60 and the shaft 39 in a rearward second position. In the second position the armature 50 projects into the space between the inner and outer cylinders 69 and 70 of the field 68 so that the armature 50 and the field 68 are axially aligned, and relative rotation between the armature 50 and the field 68 will generate electricity.

A plurality of ball bearings 73 are positioned at the front of the space between the inner and outer cylinders 69 and 70 of the field 68. As the forward hub 60 moves rearwardly, the front of the coils cylinder 52 contacts the ball bearings 73 to limit rearward movement of the forward hub 60. The seal 61 prevents air leakage from the inner wall 24 of the diffuser ring 15 between the rearward and forward portions 21 and 22 when the forward hub 60 is in the second position. A means for rotating the armature 50 and the field 68 in opposite directions, in the form of a counter rotating mechanism 74, mounted on the shaft 39 between the rearward and forward hubs 32 and 60, also limits rearward movement of the forward hub 60 to the same axial position to which the ball bearings 73 limit movement.

Referring to FIGS. 7 and 8, the counter rotating mechanism 74 includes a drive portion 76, an intermediate portion 77 and a driven portion 78. The drive portion 76 mounts on the back of the forward hub 60 and extends rearwardly. The drive portion 76 is generally cylindrical and has a plurality of spaced, rearwardly projecting teeth 80 separated by rearwardly opening, circular shaped arcs 81.

The intermediate portion 77 is mounted on the shaft 39 behind the drive portion 76. The intermediate portion 77 has a cylinder 82, a pair of spaced axles 83, two plates 84, spacers 85 and a plurality of ball bearing type cam followers 86. The cylinder 82 mounts around the shaft 39 behind the thrust bearing 64. The axles 83 extend radially outwardly from opposite sides of the shaft 39, perpendicular to the axis A-A. The cylinder 82 does not move axially relative to the drive portion 76. The plates 84 are preferably circular and rotatably mount on opposite ends of the axle 83. The spacers 85 space the plates 84 radially outwardly from the cylinder 82. The cam followers 86 are mounted in a circular pattern around the axle 83 on the inner side of each plate 84. Eight equally spaced cam followers 86 are shown on each plate 84. The teeth 80 on the drive portion 76 engage and the arcs 81 on the drive portion 76 receive the cam followers 86 so that the plates 84 rotate when the forward hub 60 rotates.

The driven portion 78 mounts on the front of the rearward hub 32 and extends forwardly. The driven portion 78 is generally cylindrical and has a plurality of spaced, forwardly projecting teeth 88 separated by forwardly opening, circular shaped arcs 89. When the forward hub 60 is in the forward, first position, the cam followers 86 are forward of the driven portion 78 and are disengaged. When the forward hub 60 is in the rearward, second position, the cam followers 86 engage the teeth 88 and are received in the arcs 89 of the driven portion 78, and the driven portion 78 rotates the rearward hub 32 in the direction opposite the direction of rotation of the forward hub 60. Other means for rotating the armature 50 and the field 68 in opposite directions, such as gears, can also be used. However regular gear teeth will not automatically mesh, especially if the forward hub 60 is smashed rearwardly to the second position by sharp edged gusts.

As shown in FIGS. 4 and 5, another means for rotating the armature 50 and the field 68 in opposite directions includes a drive ring 95, a plurality of bearings 96 and a driven ring 97. The drive ring 95 projects outwardly from the outer side of the outer cylinder 70 of the field 68. The bearings 96 are cam follower type bearings. The bearings 96 are circumferentially spaced, projecting inwardly from the forward edge of the outer wall 25 of the rearward portion 21 of the diffuser ring 15 and rotating about axes perpendicular to axis A-A. The driven ring 97 projects outwardly from the coils cylinder 52, between the rods 49 and the bearings 96, and is always in contact with the bearings 96.

When the forward hub 60 is in the forward, first position, the drive ring 95 is spaced forwardly from the bearings 96. When the forward hub 60 is in the rearward, second position, the drive ring 95 contacts and rotates the bearings 96, and the bearings 96 push the driven ring 97 and armature 50 in the direction opposite the direction of rotation of the field 68. The bearings 96 also help to maintain uniform air gaps between the armature 50 and field 68.

As best seen in FIG. 5, the storage tanks 47 are connected through a control valve 92 to an air passage 93 that extends, inside the diffuser ring 15, from the storage tanks 47 to the vanes 54. The vanes 54 on the rearward rotor 58 are angled such that air from the storage tanks 47 blowing across the vanes 54 assists the rotation of the rearward hub 32 in the direction opposite the direction of rotation of the forward hub 60. The vanes 75 on the forward rotor 67 are angled such that air from the vanes 54 on the rearward rotor 58 blowing across the vanes 75 assists the rotation of the forward hub 60. Air from the vanes 75 is reversed along the front of the inside of the forward portion 22 of the diffuser ring 15 and exits near the root cuff of the turbine blades 16, increasing lift on the root of the turbine blades 16 and preventing separation off the rearward side of the root of the turbine blades 16. The control valve 92 controls the release of air from the storage tanks 47 to smooth out electricity generation.

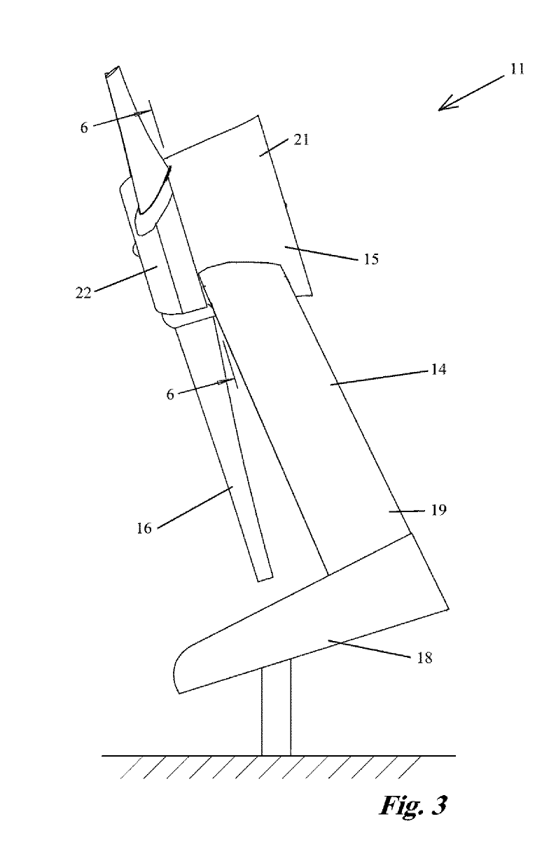

As shown in FIG. 3-5, the diffuser ring 15 and the shaft support 28 are tilted forwardly, downwardly, so that the shaft 39 and axis A-A slant forwardly, downwardly, providing a means for biasing the forward hub 60 toward the first position. By way of example, and not as a limitation, the axis A-A may be slanted about fifteen degrees or enough to slide the forward hub 60 to the first position during calm winds. Gravity pulls the forward hub forwardly to the first position. Other means for biasing the forward hub 60 toward the first position can be used. By way of example, and not as a limitation, compressed air from the storage tanks 47 could be used to completely, or in conjunction with a shaft 39 with less slant, bias the forward hub 60 toward the first position.

In still air, the forward hub 60 is rotationally stationary in the first position. Wind on the turbine blades 16 produces an axial force and a rotational force on the forward hub 60. Initially, the forward hub 60 rotates freely, since the armature 50 and the field 68 are axially separated in the first position. As the wind increases, the rotational speed of the forward hub 60 increases and the axial force pushes the forward hub 60 rearwardly towards the second position. The armature 50 and the field 68 axially align and the counter rotating mechanism 74 engages to effectively double the relative speed between the armature 50 and the field 68.

The forward hub 60 and forward rotor 67 move between the first and second positions to eliminate low speed cogging torque and provide improved start-up with iron core coils 53 in the armature 50. The use of iron core coils 53 increases the amount of electrical power generated. The radial flux C core design of the field 68 with the inner and outer cylinders 69 and 70 increases the strength of the magnetic flux and thereby increases the amount of electrical power generated. The radial flux C core design of the field 68 also localizes the torsional forces caused by interaction between the field 68 and armature 50. This localization of the torsional forces allows the armature 50 and field 68 to be supported on the relatively slender rods 49 and 66, instead of the heavy solid plates used in prior known direct drive wind turbines. Thin spokes, similar to bicycle wheel spoke, could be used to add extra strength and rigidity between the rods 49 and 66, without adding much weight or air flow losses within the diffuser ring 15.

The weight reduction resulting from the use of the rods 49 and 66 to support the field 68 and armature 50 allows the diameter of the field 68 and armature 50 to be increased. The larger diameter field 68 and armature 50 result in a higher relative speed between the field 68 and armature 50, for a given rotational rate, which increases the amount of electrical power generated. The counter rotating mechanism 74 doubles the relative speed between the field 68 and armature 50, doubling the amount of electrical power generated.

Since the armature 50 and field 68 can be supported on the relatively slender rods 49 and 66, the bulky nacelle of prior known direct drive wind turbines is replaced with the diffuser ring 15. The diffuser ring 15 acts as a diffuser, steadying the incoming wind into the turbine blades 16 and also drawing more wind in with lower backpressures at the diffuser ring 15 exit. The diffuser ring 15 is relatively small relative to blade tip diffusers, which are excessively heavy, costly and complex to build. Since the trailing edges of the airfoil-shaped struts 19 are splayed outward, the struts 19 of the tower 14 also act as a diffuser in the lowest and most turbulent wind sector nearest the ground.

The wind turbine 11 takes advantage of wind variability by pumping air with the pump piston 41 into the storage tanks 47 as the forward hub 60 moves between the first and second positions. The air in the storage tanks 47 is controlled by the control valve 92 to release compressed air back out, as needed, to smooth out electricity generation over a longer period of time.

Although the present invention has been described with a certain degree of particularity, it is understood that the present disclosure has been made by way of example and that changes in details of structure may be made without departing from the spirit thereof.

What is claimed is:

1. A direct drive wind turbine, comprising:
a support tower,
a shaft support mounted on said tower,
a shaft extending through said shaft support, projecting forwardly, and defining an axis,
a rotatable forward hub on said shaft forward from said shaft support, said forward hub being movable along said axis relative to said shaft support between a forward, axially separated first position and a rearward, axially aligned second position,
a plurality of circumferentially spaced turbine blades projecting radially outwardly from said forward hub, said turbine blades being responsive to a wind to rotate said forward hub and to push said forward hub rearwardly,
a generator armature mounted on and spaced radially outwardly from one of said shaft support and said forward hub,
a generator field mounted on the other of said shaft support and said forward hub, said field being sized and shaped to align adjacent to said armature with a selected air gap, said armature and said field being axially spaced significantly apart in said first position and spaced apart by said air gap in said second position, and
means for biasing said forward hub toward said first position,
whereby, as said wind increases, wind pressure moves said forward hub to said second position, to axially align said armature and field to produce electrical power.

2. The wind turbine as set forth in claim 1 wherein said field includes a plurality of circumferentially spaced permanent magnets.

3. The wind turbine as set forth in claim 2 wherein said armature is cylindrical and said field is sized to fit concentrically with said armature.

4. The wind turbine as set forth in claim 3 wherein said field includes an inner cylinder of said magnets and a radially spaced outer cylinder of said magnets, said inner and outer cylinders being spaced a selected distance to receive said armature between said inner and outer cylinders with selected air gaps.

5. The wind turbine as set forth in claim 1:
wherein said shaft support includes a rotatable rearward hub with one of said armature and said field being mounted on said rearward hub, and
including means, connected to said forward hub and said rearward hub, for rotating said armature and said field in opposite directions to increase the relative rotational speed between said armature and said field.

6. The wind turbine as set forth in claim 5 wherein said means for rotating engages when said forward hub is in said second position and disengages when said forward hub is in said first position.

7. The wind turbine as set forth in claim 5 wherein said means for rotating includes a drive portion mounted on and rotating with said forward hub, a driven portion mounted on and rotating with said rearward hub, and an intermediate portion between said drive portion and said driven portion and rotatable perpendicular to said axis, with said drive portion engaging said intermediate portion and said intermediate portion engaging said driven portion to rotate said rearward hub in the direction opposite said forward hub when said forward hub is in said second position.

8. The wind turbine as set forth in claim 7 wherein:
said drive portion is cylindrical with a plurality of spaced, rearwardly projecting teeth that are separated by rearwardly opening, circular arc shaped arcs,
said driven portion is cylindrical with a plurality of spaced, forwardly projecting teeth that are separated by forwardly opening, circular arc shaped arcs, and
said intermediate portion includes a plate mounted on said shaft and rotatable perpendicular to said axis, and a plurality of spaced cam followers mounted on said plate in a circular arrangement and sized to engage said arcs on said drive and driven portions.

9. The wind turbine as set forth in claim 5 wherein said means for rotating includes:
an air storage tank with compressed air,
a plurality of circumferentially spaced, angled vanes on said rearward hub,
an air passage extending from said air storage tank to said vanes on said rearward hub, and
a plurality of circumferentially spaced vanes on said forward hub, said vanes on said forward hub being angled opposite said vanes on said rearward hub,
whereby air from said air storage tank rotates said rearward hub in one direction and said forward hub in an opposite direction to rotate said armature and said field in opposite directions.

10. The wind turbine as set forth in claim 1 wherein said means for biasing includes said shaft being tilted forwardly, downwardly such that gravity pulls said forward hub toward said first position.

11. The wind turbine as set forth in claim 10 wherein said shaft is slidably mounted in said shaft support.

12. The wind turbine as set forth in claim 11 including:
inner and outer pump walls connected rearwardly from said shaft support with said shaft projecting inside said inner pump wall, and
an air storage tank with a one way valve connected to said inner pump wall,
whereby said shaft pumps air into said air storage device when said forward hub moves to said second position.

13. The wind turbine as set forth in claim 1 wherein:
said shaft support includes a plurality of circumferentially spaced, radially outwardly projecting rods,
said armature is mounted on said rods on said shaft support,
said forward hub includes a plurality of circumferentially spaced, radially outwardly projecting rods, and
said field is mounted on said rods on said forward hub.

14. The wind turbine as set forth in claim 13 including a diffuser ring having a rearward portion and a forward portion, said rearward portion being mounted on said tower, supporting said shaft support and at least partially enclosing said armature, and said forward portion being mounted on said rods on said forward hub and enclosing said field.

15. The wind turbine as set forth in claim 14 wherein said turbine blades extend from said forward portion of said diffuser ring radially outwardly to a selected blade radius from said axis, and said diffuser ring has a radius that is about twenty percent of said blade radius.

16. The wind turbine as set forth in claim 1 wherein said armature includes a plurality of iron core coils.

17. The wind turbine as set forth in claim 16 wherein said coils are laminated silicon steel core coils.

18. A direct drive wind turbine, comprising:
a support tower,
a shaft support mounted on said tower with rotatable rearward hub having a plurality of circumferentially spaced, radially outwardly projecting rods,
a shaft mounted in and extending through said shaft support, said shaft projecting forwardly from said shaft support and defining a rotational axis, said axis being tilted forwardly, downwardly,
a forward hub rotatably mounted on said shaft forward from said shaft support, said forward hub including a plurality of circumferentially spaced, radially outwardly projecting rods, said shaft being slidable in said shaft support such that said forward hub is movable along said axis relative to said shaft support between a forward, axially separated first position and a rearward, axially aligned second position,
a cylindrical generator armature mounted on said rods on said shaft support, said armature including a plurality of iron core coils,
a generator field mounted on said rods on said forward hub, said field including an inner cylinder sized to fit concentrically, radially inwardly of said armature and a radially spaced outer cylinder sized to fit concentrically, radially outwardly of said armature, said inner and outer cylinders each having a plurality of circumferentially spaced permanent magnets, said armature and said field being axially spaced apart in said first position and said armature fitting between said inner and outer cylinders of said field in said second position, and
a plurality of circumferentially spaced turbine blades mounted on and projecting radially outwardly from said rods on said forward hub, said turbine blades being responsive to a wind to rotate said forward hub and to push said forward hub rearwardly,
whereby, gravity slides said forward hub forwardly to said first position when there is no wind, and said turbine blades rotate said forward hub in response to said wind and, as said wind increases, wind pressure progressively moves said forward hub to said second position, to axially align said armature and field to produce electrical power.
